(19) United States
(12) Patent Application Publication
(10) Pub. No.: US 2025/0300546 A1
(43) Pub. Date: Sep. 25, 2025

(54) ELECTRICAL SYSTEM RESONANCE DAMPER

(71) Applicant: Caterpillar Inc., Peoria, IL (US)

(72) Inventors: Zachary Thomas Kroehler, Peoria, IL (US); Carlos E. Nino Baron, Edwards, IL (US); Srevidhya Devi, Chennai (IN)

(73) Assignee: Caterpillar Inc., Peoria, IL (US)

(21) Appl. No.: 18/613,962

(22) Filed: Mar. 22, 2024

(51) Int. Cl. H02M 1/12; H01B 1/02; H02M 1/00; H02M 3/00; H02M 7/48; H02M 7/537

(52) U.S. Cl. CPC H02M 1/12; H01B 1/026; H02M 1/0048; H02M 3/003; H02M 7/4815; H02M 7/537

(57) ABSTRACT

Techniques are described to strategically use materials with low DC resistance but high AC resistance, such as stainless steel or electrical steel, like iron alloys such as ferrosilicon (FeSi), to exploit the skin effect phenomenon. By integrating a conductor with a higher skin effect than copper into the cable circuit, the AC resistance is increased, leading to a more damped circuit that maintains the same level of AC losses. This technique allows for the attenuation of AC currents to acceptable levels, enhancing the stability and reliability of the electrical system. The technique takes advantage of the skin effect to provide targeted damping at the resonant frequency, thereby mitigating the risk of resonance without compromising the system's efficiency.

### FIELD OF THE DISCLOSURE

This document pertains generally, but not by way of limitation, to electrical systems and attenuation of AC currents in those electrical systems.

### BACKGROUND

In modern electrical systems, particularly those involving complex machinery and high-powered components, the phenomenon of electrical resonance poses a significant challenge. Electrical resonance occurs when the inductive and capacitive elements within a circuit interact in such a way that they amplify the voltage or current at a particular frequency. This may lead to a range of undesirable effects, from reduced efficiency and increased energy consumption to potential damage to system components.

The problem of resonance is exacerbated in systems that incorporate a variety of electrical components, such as generators, inverters, and motors, each with their own unique electrical characteristics. When these components are interconnected, the overall system may exhibit a composite inductive and capacitive behavior that may lead to resonance at certain frequencies. The likelihood of such resonance effects increases with the complexity of the system and the range of operating conditions it must endure.

Historically, the issue of resonance in electrical systems has been addressed through various means, often involving the adjustment of the system's natural frequency or the introduction of additional circuit elements to dampen oscillations. However, these solutions may be limited by practical considerations such as space, cost, and the inherent electrical properties of the components involved. As electrical systems continue to evolve, becoming more sophisticated and integrated, the need for innovative approaches to manage and mitigate resonance becomes ever more critical. The ability to ensure stable operation across a wide range of frequencies and under varying load conditions is a key requirement for the reliability and longevity of modern electrical systems.

U.S. Pat. No. 9,667,043 describes a device for damping high-frequency currents. The device includes a conductor extending along a main axis, a first damping path including a first damping element extending along a first axis and a second damping path including a second damping element extending along a second axis. The first and second damping elements are arranged on opposite sides of the conductor. The main axis, the first axis and the second axis are different and separate from each other. The first damping element and the second damping element are spaced apart from the conductor and electrically connected in parallel with the conductor between a first position and a second position along the conductor. Further, from the first position to the second position, a resistance of the conductor is lower than a resistance of either one of the first and second damping paths.

### SUMMARY OF THE DISCLOSURE

This disclosure describes techniques to strategically use materials with low DC resistance but high AC resistance, such as stainless steel or electrical steel, like iron alloys such as ferrosilicon (FeSi), to exploit the skin effect phenomenon. By integrating a conductor with a higher skin effect than copper into the cable circuit, the AC resistance is increased, leading to a more damped circuit that maintains the same level of AC losses. This technique allows for the attenuation of AC currents to acceptable levels, enhancing the stability and reliability of the electrical system. The technique takes advantage of the skin effect to provide targeted damping at the resonant frequency, thereby mitigating the risk of resonance without compromising the system's efficiency. By doing so, the need for oversizing components is eliminated, resulting in a more cost-effective and energy-efficient electrical system design.

In some aspects, this disclosure is directed to an electrical system for a machine, the electrical system comprising: a first power converter configured for generating a direct current (DC) output, wherein the DC output includes a positive DC rail and a negative DC rail, wherein a capacitor is electrically coupled between the positive DC rail and the negative DC rail; a second power converter electrically coupled with the first power converter, wherein an electrical resonance is generated between the first power converter and the second power converter; and an AC damping resistor electrically coupled between the first power converter and the second power converter, wherein the AC damping resistor is configured for attenuating AC currents to reduce the electrical resonance, and wherein the AC damping resistor has a predetermined skin effect value.

In some aspects, this disclosure is directed to a method for fabricating an AC damping resistor for damping resonance in an electrical system, the method comprising: selecting a material having a resistivity and a magnetic permeability; determining a target resistance for the AC damping resistor at a desired frequency; determining a skin depth based on the desired frequency, the resistivity, and the magnetic permeability; and forming the AC damping resistor with dimensions corresponding to the determined skin depth to achieve the target resistance at the desired frequency.

In some aspects, this disclosure is directed to a method for damping AC currents in an electrical system having capacitors coupled between a positive DC rail and a negative DC rail, the method comprising: selecting an AC damping resistor configured for attenuating AC currents to reduce an electrical resonance, wherein the AC damping resistor has a predetermined skin effect value; and coupling the AC damping resistor between a first power converter of the electrical system and a second power converter and electrical system, wherein the first power converter is coupled with the second power converter.

### BRIEF DESCRIPTION OF THE DRAWINGS

In the drawings, which are not necessarily drawn to scale, like numerals may describe similar components in different views. Similar components in different views may be described by like numerals. The drawings illustrate generally, by way of example, but not by way of limitation, various embodiments discussed in the present document.

FIG. 1 is a perspective view of an example of an electric machine having an electrical system that may implement various techniques of this disclosure.

FIG. 2 is a block diagram of an example of an electrical system that may implement various techniques of this disclosure.

FIG. 3 is a block diagram of a portion of the electrical system of FIG. 2.

FIG. 4 is a block diagram of another example of an electrical system that may implement various techniques of this disclosure.

FIG. 5 depicts an example of an AC damping resistor that may be used in accordance with this disclosure.

FIG. 6 is a flow diagram of an example of a method 600 for fabricating an AC damping resistor for damping resonance in an electrical system.

FIG. 7 is a flow diagram of an example of a method for damping AC currents in an electrical system having capacitors coupled between a positive DC rail and a negative DC rail.

### DETAILED DESCRIPTION

Modern electrical systems that incorporate direct current (DC) circuits with large capacitors, such as X-capacitors, are vulnerable to resonance issues when these capacitors are connected through cables. The phenomenon of electrical resonance is characterized by the amplification of AC currents at certain frequencies, which may lead to various problems. When inverters are connected to these systems and operate at or near the resonant frequency, the circuits exhibit minimal damping, resulting in dangerously high AC currents. This lack of sufficient damping at the resonant frequency may cause premature failure of cables, capacitors, and other system components.

The present inventors have recognized that existing techniques to counteract this issue, such as adding resistors, introduce significant DC resistance, leading to unwanted power losses. Another existing approach involves adjusting the inductance and capacitance to shift the resonant frequency, but this may be impractical and may not address the fundamental issue. The quality factor (Q) of the cable, which is the ratio of reactance to resistance at the resonance point, is typically higher than 1, indicating a system that is highly susceptible to resonance. These high levels of AC current are a major concern for the lifespan of components and may necessitate the oversizing of the electrical system to handle the AC currents, resulting in increased costs and inefficiency.

To address the challenges posed by electrical resonance and its associated AC currents, the present inventors propose a solution that increases the damping in the system without introducing additional DC losses. This disclosure describes techniques to strategically use materials with low DC resistance but high AC resistance, such as stainless steel or electrical steel, like iron alloys such as ferrosilicon (FeSi), to exploit the skin effect phenomenon. By integrating a conductor with a higher skin effect than copper into the cable circuit, the AC resistance is increased, leading to a more damped circuit that maintains the same level of AC losses. This technique allows for the attenuation of AC currents to acceptable levels, enhancing the stability and reliability of the electrical system. The technique takes advantage of the skin effect to provide targeted damping at the resonant frequency, thereby mitigating the risk of resonance without compromising the system's efficiency. By doing so, the need for oversizing components is eliminated, resulting in a more cost-effective and energy-efficient electrical system design.

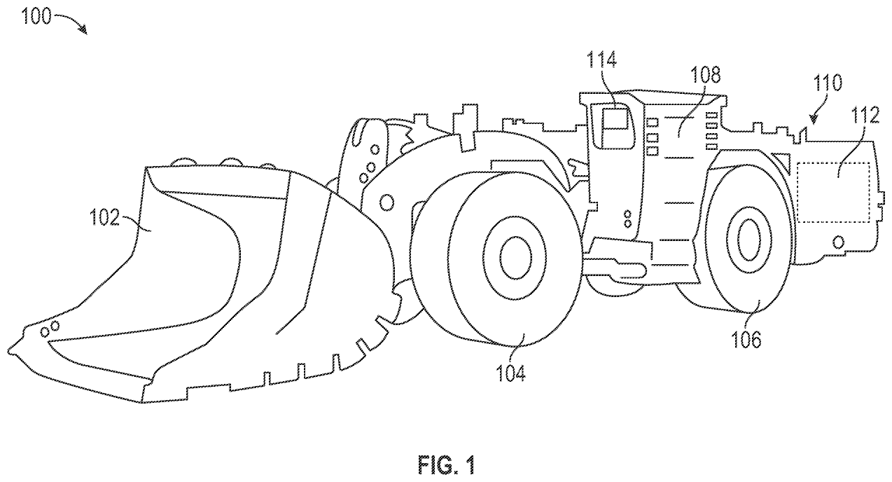

FIG. 1 is a perspective view of an example of an electric machine 100. FIG. 1 depicts a non-limiting view of an electric machine 100 in the form of a load-haul-dump (LHD) vehicle, such as for mining, including a dump bucket 102, wheels 104, 106, an operator control cabin 108, and a vehicle body 110. The wheels 104, 106 are examples of traction components. In other examples, the electric machine 100 may include traction components such as one or more tracks, in addition to or instead of the wheels.

The electric machine 100, e.g., an electric mine truck, also includes an electrical system 112 that may implement various techniques of this disclosure. The electrical system 112 may include a DC power source, including but not limited to one or more battery strings, which may supply power to, among other things, an electric motor. The electric motor may supply rotational power to one or more systems, such as a system configured to operate various hydraulics of the dump bucket 102. The electrical system 112 may supply power to at least one traction component, such as the wheels 104, 106, and to at least one accessory component 114, such as a pump motor, fan, and the like. In some examples, the electric machine 100 may include electric vehicles, such as cars, trucks, motorcycles, buses, and the like.

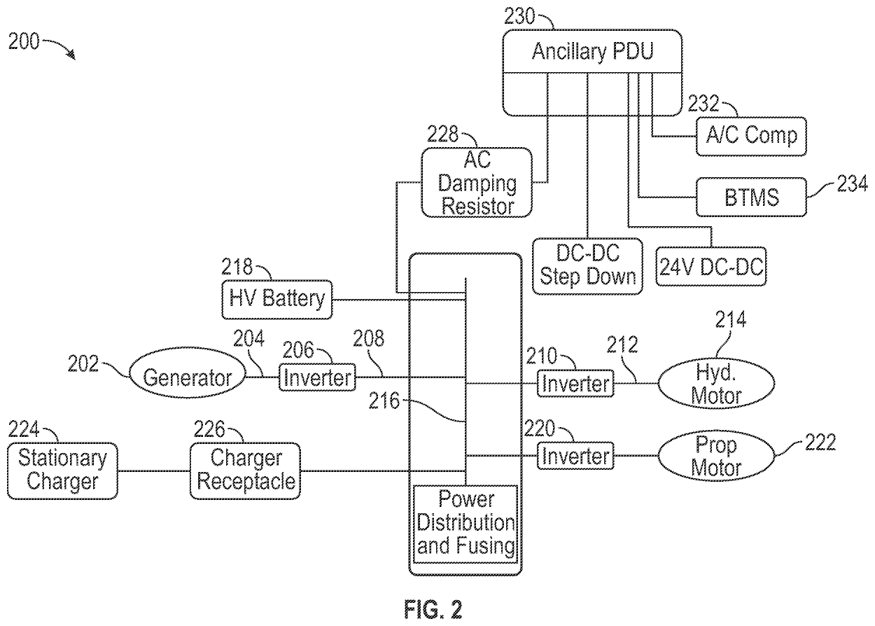

FIG. 2 is a block diagram of an example of an electrical system 200 that may implement various techniques of this disclosure. The electrical system 200 is an example of the electrical system 112 of FIG. 1.

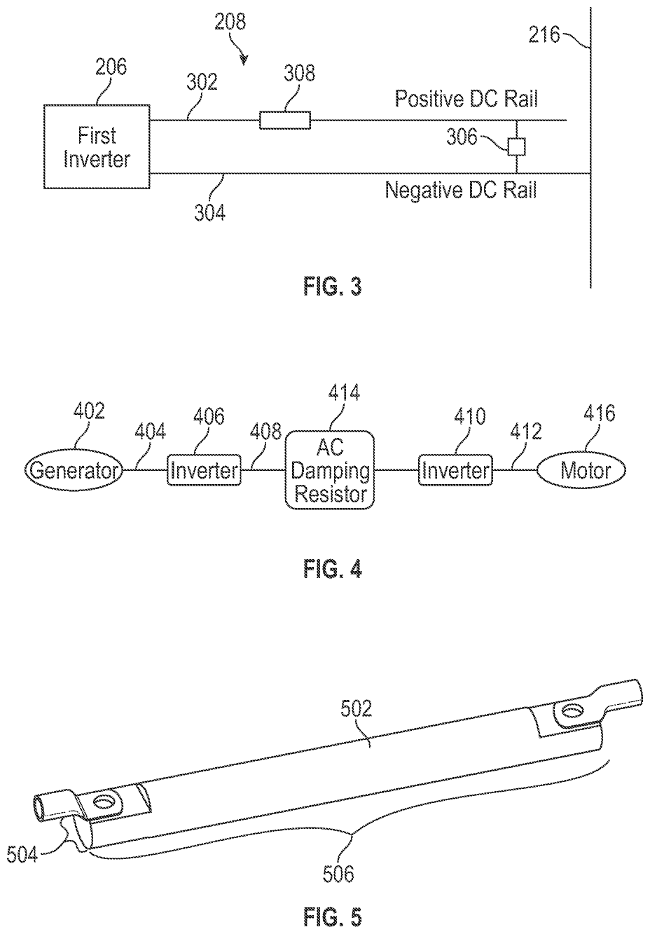

The electrical system 200 includes a generator 202 configured for producing a first alternating current (AC) output 204. A first inverter 206, e.g., a power converter including switches operating at a switching frequency to produce an output voltage, is electrically coupled with the generator 202 and configured for converting the AC output 204 to a direct current (DC) output. As seen below in FIG. 3, the DC output 208 includes a positive DC rail and a negative DC rail. One or more capacitors, e.g., X-capacitors, are electrically coupled between the positive DC rail and the negative DC rail.

A second inverter 210, e.g., a power converter including switches operating at a switching frequency to produce an output voltage, is electrically coupled with the first inverter 206. The second inverter 210 is configured for converting the DC output 208 to a second AC output 212. An electrical resonance is generated between the first inverter 206 and the second inverter 210, which may be reduced using various techniques of this disclosure. The second inverter 210 may be electrically coupled with a hydraulic motor 214, which may control various hydraulically operated components of the machine, such as the electric machine 100 of FIG. 1.

In the example shown in FIG. 2, the electrical system 200 includes an electrical bus 216 electrically coupled with the first inverter 206. A battery 218, e.g., a high-voltage battery, is electrically coupled with the electrical bus 216 and configured for receiving or supplying power to the electrical bus 216. A third inverter 220 may be electrically coupled with the electrical bus 216 and with a propulsion motor 222, which may control various propulsion components of the machine, such as the electric machine 100 of FIG. 1.

A stationary charger 224 is electrically coupled with the electrical bus 216, via a charger receptacle 226. The stationary charger 224 provides power to charge the battery 218.

In accordance with this disclosure, the electrical system 200 includes an AC damping resistor 228 electrically coupled between the first inverter 206 and the second inverter 210. For example, in the non-limiting configuration depicted in FIG. 2, an electrical bus 216 is electrically coupled between the first inverter 206 and the AC damping resistor 228.

The electrical system 200 shown in FIG. 2 further includes an ancillary power distribution unit 230. The AC damping resistor 228 may be coupled between the electrical bus 216 and the ancillary power distribution unit 230. Additional components may be powered by the ancillary power distribution unit 230, such as a compressor 232 and battery thermal management system 234.

The AC damping resistor 228 is configured for attenuating AC currents to reduce the electrical resonance in the electrical system 200 and has a predetermined skin effect value. The AC damping resistor takes advantage of the skin effect to dampen the electrical system 200 without increasing DC losses.

An electrical system may be underdamped when wires are used in between components with large capacitance (inverters, DC-DC converters, and the like). By analyzing an electrical system including wires, inductors, and capacitors, the characteristics of the electrical system may be determined, which allows the selection of an AC damping resistor to take the system from a damping coefficient much less than 1 to one that is about 1.

The sources of the unwanted AC current output include any component connected to the DC electrical bus 216, where the component has switches, e.g., transistors, operating at a switching frequency to produce an output voltage. The switching of the switches generates the unwanted AC current. Examples of such components include power converters, such as inverters and DC-DC converters, or components that include power converters. In the example shown in FIG. 2, the first inverter 206 is configured for converting the AC output 204 to the DC output 208, but the switches of the first inverter 206 generate an unwanted AC output due to their switching frequency.

The skin depth is defined by Equation 1 below:

$$skin depth = \sqrt{2 \times resistivity / ( frequency \times magnetic permeability )} \qquad ( 1 )$$

As seen above in Equation 1, skin depth is a function of frequency and the material properties of resistivity and magnetic permeability. By knowing the frequency and the material properties, e.g., resistivity and magnetic permeability per unit length, the skin depth may be estimated.

Using a target AC resistance and a known DC resistance, as well as the skin depth determined from Equation 1, a radius of the AC damping resistor may be determined using Equation 2 below:

$$AC Resistance ≅ \frac{DC Resistance}{\frac{π * {radius}^{2} - {( radius - skin depth )}^{2}}{π * {radius}^{2}}} \qquad ( 2 )$$

The DC resistance is a function of the radius and length of the material of the AC damping resistor. In some examples, Equation 2 may be solved using an iterative process until a radius is determined. In the iterative process of solving for the radius, Equation 2 takes into account the skin depth, which is influenced by the resistivity and magnetic permeability of the material-both intrinsic properties defined per unit length. The calculated radius may be evaluated in the context of the material's length to ensure practical applicability; a radius that is disproportionate to the length may not be physically realizable or may not be desirable to use within the electrical system.

By way of a non-limiting example for purposes of explanation only, to target 50milliohms (mOhms) in the AC damping resistor at 2000 Hertz (Hz) using electrical steel with silicon (Si) content around 6.5% (FeSi6.5) as the material results in the following values for dimensions: 25 millimeter (mm) diameter and 250 mm long and a DC Resistance of 0.41 mOhms, which at 2,000 Hz is about 120 times the resistance to DC. These dimensions may be further modified to optimize heat transfer, for example.

In some examples, the AC damping resistor is configured for exhibiting a DC resistance that is less than 10% of a total circuit resistance of the electrical system, and exhibiting an AC resistance, at a selected frequency due to the skin effect value, that is at least five times greater than the DC resistance, such as ten times greater than the DC resistance.

FIG. 3 is a block diagram of a portion of the electrical system 200 of FIG. 2. As mentioned above, the first inverter 206 is configured for generating a DC output 208. The DC output 208 includes a positive DC rail 302 and a negative DC rail 304. In the electrical system 200 of FIG. 2, one or more capacitors 306, e.g., X-capacitors, are electrically coupled between the positive DC rail 302 and the negative DC rail 304.

In some examples, an AC damping resistor is electrically connected in series with one or more power converters in an electrical system, such as the electrical system 200 of FIG. 2 For example, the AC damping resistor 308 is electrically connected in series with the first inverter 206 in FIG. 3.

FIG. 4 is a block diagram of another example of an electrical system 400 that may implement various techniques of this disclosure. The electrical system 400 is another example of the electrical system 112 of FIG. 1. In FIG. 4, the electrical system 400 forms part of a drivetrain.

The electrical system 400 includes a generator 402 configured for producing a first alternating current (AC) 404. A first inverter 406, e.g., a power converter including switches operating at a switching frequency to produce an output voltage, is electrically coupled with the generator 402 and configured for converting the AC output 204 to a direct current (DC) output 408. Like in FIG. 3, the DC output 408 includes a positive DC rail and a negative DC rail. One or more capacitors, e.g., X-capacitors, are electrically coupled between the positive DC rail and the negative DC rail.

A second inverter 410, e.g., a power converter including switches operating at a switching frequency to produce an output voltage, is electrically coupled with the first inverter 406. The second inverter 410 is configured for converting the DC output 408 to a second AC output 412. An electrical resonance is generated between the first inverter 406 and the second inverter 410, which may be reduced by electrically coupling an AC damping resistor 414 between the first inverter 406 and the second inverter 410. The second inverter 410 may be electrically coupled with a motor 416 of a drivetrain.

FIG. 5 depicts an example of an AC damping resistor 502 that may be used in accordance with this disclosure. The AC damping resistor 502 has a cylindrical shape with a diameter 504 and a length 506 configured to achieve a predetermined skin effect value as a specific operating frequency of the electrical system.

In some examples, the AC damping resistor 502 consists of a single, solid cylindrical shape through which all of the current will flow, such as shown in FIG. 5. In some examples, the AC damping resistor 502 consists of a solid shape, such as having a square or rectangular cross-section. In some examples, the AC damping resistor 502 includes electrical steel.

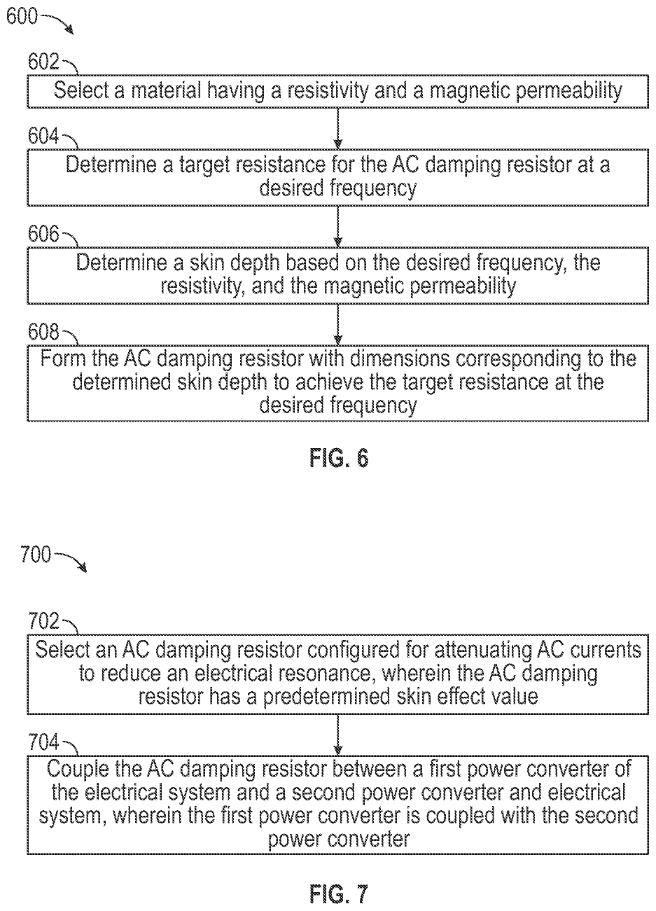

FIG. 6 is a flow diagram of an example of a method 600 for fabricating an AC damping resistor for damping resonance in an electrical system. At block 602, the method 600 includes selecting a material having a resistivity and a magnetic permeability. Examples of materials include steel, copper, aluminum, and alloys thereof, such as electrical steel.

At block 604, the method 600 includes determining a target resistance for the AC damping resistor at a desired frequency.

At block 606, the method 600 includes determining a skin depth based on the desired frequency, the resistivity, and the magnetic permeability. For example, using Equation 1, a skin depth based on the desired frequency, the resistivity, and the magnetic permeability is determined.

At block 608, the method 600 includes forming the AC damping resistor with dimensions corresponding to the determined skin depth to achieve the target resistance at the desired frequency, such as including forming the AC damping resistor into a cylindrical shape, a solid shape, or a solid cylindrical shape. In some examples, the cylindrical shape has a diameter and a length, and the diameter and the length are selected based on the determined skin depth.

FIG. 7 is a flow diagram of an example of a method 700 for damping AC currents in an electrical system having capacitors coupled between a positive DC rail and a negative DC rail. At block 702, the method 700 includes selecting an AC damping resistor configured for attenuating AC currents to reduce an electrical resonance, wherein the AC damping resistor has a predetermined skin effect value. For example, the method 700 includes selecting the AC damping resistor with a resistance value based on the predetermined skin effect value at a specific operating frequency of the electrical system. In some examples, the method 700 includes selecting a solid shape for the AC damping resistor. In some examples, the method 700 includes selecting a cylindrical shape for the AC damping resistor. In some examples, the method 700 includes selecting electrical steel as a material for the AC damping resistor.

At block 704, the method 700 includes coupling the AC damping resistor between a first power converter of the electrical system and a second power converter and electrical system, wherein the first power converter is coupled with the second power converter. For example, the method 700 includes connecting the AC damping resistor in series with at least one of the first inverter and the second inverter.

### INDUSTRIAL APPLICABILITY

The techniques of this disclosure find industrial applicability in the field of battery electric hybrid machines, such as within their drivetrain systems. These advanced machines, which are at the forefront of combining traditional combustion engines with electric propulsion, require robust electrical systems capable of handling high currents with minimal losses. The method of damping AC currents using a component that exhibits low DC resistance and high AC resistance is especially beneficial in this context. It ensures that the drivetrains of these machines operate efficiently, with reduced risk of component failure due to electrical resonance. By integrating this damping technique, manufacturers can enhance the performance and reliability of hybrid drivetrains, leading to longer service life and improved energy efficiency, which are critical factors for consumer acceptance and regulatory compliance.

Beyond hybrid machines, the damping techniques have significant implications for the broader automotive industry, including fully electric vehicles. As the automotive sector continues to shift towards electrification, the need for efficient and reliable electrical systems becomes increasingly paramount. The techniques provide a solution that can be integrated into the design of electric vehicle power electronics, such as inverters and converters, to mitigate resonance without compromising power density or efficiency.

The techniques may also extend to other sectors, such as the renewable energy sector, as well as industrial applications, such as those involving heavy machinery and automated manufacturing systems.

In conclusion, while the invention is primarily focused on improving battery electric hybrid machines and their drivetrains, its utility extends to a multitude of industries that rely on advanced electrical systems. Its ability to dampen electrical resonance effectively without additional DC losses presents a valuable innovation for enhancing the performance and reliability of a wide array of electrical and electronic systems.

### Various Notes

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. An electrical system for a machine, the electrical system comprising:
a first power converter configured for generating a direct current (DC) output, wherein the DC output includes a positive DC rail and a negative DC rail, wherein a capacitor is electrically coupled between the positive DC rail and the negative DC rail;
a second power converter electrically coupled with the first power converter, wherein an electrical resonance is generated between the first power converter and the second power converter; and
an AC damping resistor electrically coupled between the first power converter and the second power converter, wherein the AC damping resistor is configured for attenuating AC currents to reduce the electrical resonance, and wherein the AC damping resistor has a predetermined skin effect value.

2. The electrical system of claim 1, wherein the electrical system forms a portion of a drivetrain of the machine.

3. The electrical system of claim 2, wherein the first power converter includes an inverter.

4. The electrical system of claim 1, wherein the AC damping resistor has a cylindrical shape with a diameter and length configured to achieve the predetermined skin effect value at a frequency.

5. The electrical system of claim 4, wherein the AC damping resistor consists of a solid cylindrical shape.

6. The electrical system of claim 1, wherein the AC damping resistor includes electrical steel.

7. The electrical system of claim 1, wherein the AC damping resistor is configured for exhibiting a DC resistance that is less than 10% of a total circuit resistance of the electrical system, and exhibiting an AC resistance, at a selected frequency due to the skin effect value, that is at least five times greater than the DC resistance.

8. The electrical system of claim 1, wherein the AC damping resistor electrically coupled between the first power converter and the second power converter is connected in series with at least one of the first power converter and the second power converter.

9. The electrical system of claim 1, comprising:
an electrical bus coupled between the first power converter and the AC damping resistor.

10. A method for fabricating an AC damping resistor for damping resonance in an electrical system, the method comprising:
selecting a material having a resistivity and a magnetic permeability;
determining a target resistance for the AC damping resistor at a desired frequency;
determining a skin depth based on the desired frequency, the resistivity, and the magnetic permeability; and
forming the AC damping resistor with dimensions corresponding to the determined skin depth to achieve the target resistance at the desired frequency.

11. The method of claim 10, wherein forming the AC damping resistor with dimensions corresponding to the determined skin depth to achieve the target resistance at the desired frequency includes:
forming the AC damping resistor into a cylindrical shape.

12. The method of claim 11, wherein the cylindrical shape has a diameter and a length, and the diameter and the length are selected based on the determined skin depth.

13. The method of claim 10, wherein forming the AC damping resistor with dimensions corresponding to the determined skin depth to achieve the target resistance at the desired frequency includes:
forming the AC damping resistor into a solid shape.

14. The method of claim 10, wherein selecting the material having the resistivity and the magnetic permeability includes:
selecting a material from the group consisting of steel, copper, aluminum, and alloys thereof.

15. A method for damping AC currents in an electrical system having capacitors coupled between a positive DC rail and a negative DC rail, the method comprising:
selecting an AC damping resistor configured for attenuating AC currents to reduce an electrical resonance, wherein the AC damping resistor has a predetermined skin effect value; and
coupling the AC damping resistor between a first power converter of the electrical system and a second power converter and electrical system, wherein the first power converter is coupled with the second power converter.

16. The method of claim 15, wherein selecting the AC damping resistor configured for attenuating AC currents to reduce an electrical resonance includes:
selecting the AC damping resistor with a resistance value based on the predetermined skin effect value at a specific operating frequency of the electrical system.

17. The method of claim 15, wherein selecting the AC damping resistor configured for attenuating AC currents to reduce an electrical resonance includes:
selecting a solid shape for the AC damping resistor.

18. The method of claim 15, wherein selecting the AC damping resistor configured for attenuating AC currents to reduce an electrical resonance includes:
selecting a cylindrical shape for the AC damping resistor.

19. The method of claim 15, wherein selecting the AC damping resistor configured for attenuating AC currents to reduce an electrical resonance includes:
selecting electrical steel as a material for the AC damping resistor.

20. The method of claim 15, wherein coupling the AC damping resistor between the first power converter of the electrical system and the second power converter and electrical system includes:
connecting the AC damping resistor in series with at least one of the first power converter and the second power converter.
